(19) United States
(12) Patent Application Publication
(10) Pub. No.: US 2021/0148829 A1
(43) Pub. Date: May 20, 2021

(54) READING DEVICE FOR A LATERAL FLOW TEST STRIP

(71) Applicant: Sumitomo Chemical Company Limited, Tokyo (JP)

(72) Inventor: Andrey Nikolaenko, Huntington (GB)

(73) Assignee: Sumitomo Chemical Company Limited, Tokyo (JP)

(21) Appl. No.: 16/622,828

(22) PCT Filed: Jun. 13, 2018
(86) PCT No.: PCT/GB2018/051604

§ 371 Date: Dec. 13, 2019

(30) Foreign Application Priority Data
Jun. 16, 2017 (GB) 1709656.1

(51) Int. Cl. G01N 21/84; G01N 21/78

(52) U.S. Cl. CPC G01N 21/8483; G01N 2021/752; G01N 21/78

(57) ABSTRACT

Reading device for a lateral flow test strip. A reading device (26) for a lateral flow test strip (2) includes a sample receiving volume (27) disposed between first and second faces (28, 29) spaced apart in a first direction (z). The sample receiving volume (27) is configured to receive at least a portion of a lateral flow test strip (2) between the first and second faces (28, 29) such that a longitudinal axis of the lateral flow test strip (2) is aligned in a second direction (x) transverse to the first direction (z). The reading device (26) also includes a light emitter (32) arranged to illuminate a reading portion (34) of the sample receiving volume (27). The reading device (26) also includes a photodetector (37) arranged to receive light from the reading portion (34). A width of the reading portion (34) in the second direction (x) is greater than a width of a test region (5) of the lateral flow test strip (2) in the second direction (x).

### FIELD OF THE INVENTION

The present invention relates to reading devices for lateral flow test strips.

### BACKGROUND

Biological testing for the presence and/or concentration of an analyte may be conducted for a variety of reasons including, amongst other applications, preliminary diagnosis, screening samples for presence of controlled substances and management of long term health conditions.

Lateral flow devices (also known as “lateral flow immunoassays”) are one variety of biological testing. Lateral flow devices may be used to test a liquid sample, such as saliva, blood or urine, for the presence of an analyte. Examples of lateral flow devices include home pregnancy tests, home ovulation tests, tests for other hormones, tests for specific pathogens and tests for specific drugs. For example, EP 0 291 194 A1 describes a lateral flow device for performing a pregnancy test.

In a typical lateral flow testing strip, a liquid sample is introduced at one end of a porous strip which is then drawn along the strip by capillary action (or “wicking”). A portion of the lateral flow strip is pre-treated with labelling particles which are activated with a reagent which binds to the analyte to form a complex, if the analyte is present in the sample. The bound complexes and also unreacted labelling particles continue to propagate along the strip before reaching a test region which is pre-treated with an immobilised binding reagent which binds bound complexes of analyte and labelling particles and does not bind unreacted labelling particles. The labelling particles have a distinctive colour, or other detectable optical or non-optical property, and the development of a concentration of labelling particles in the test region provides an observable indication that the analyte has been detected. Lateral flow test strips may be based on, for example, calorimetric labelling using gold or latex nanoparticles, fluorescent marker molecules or magnetic labelling particles.

Sometimes, merely determining the presence or absence of an analyte is desired, i.e. a qualitative test. In other applications, an accurate concentration of the analyte may be desired, i.e. a quantitative test. For example, WO 2008/101732 A1 describes an optical measuring instrument and measuring device. The optical measuring instrument includes at least one source for providing at least one electromagnetic beam to irradiate a sample and to interact with the specimen within the sample, at least one sensor for detecting an output of the interaction between the specimen and the electromagnetic beam, an integrally formed mechanical bench for the optical and electronic components and a sample holder for holding the sample. The at least one source, the at least one sensor, and the mechanical bench are integrated in one monolithic optoelectronic module and the sample holder can be connected to this module.

WO 03/058220 A1 describes an optical reflectance kit including a reading device and membrane test strip for conducting a lateral flow assay. The membrane test strip may be inserted directly into a receiving port of a reading device. Stray light is shielded from the receiving port by a light-absorbing member that is positioned above the membrane test strip. The reading device also includes one or more sensors capable of detecting the intensity of reflected electromagnetic radiation.

WO 2015/121672 A1 describes an assay device including a planar emitter which is an organic light emitting diode, a planar detector which is an organic photodiode, and a lateral flow membrane interposed between the emitter and the detector. The lateral flow membrane includes reaction lines, and the planar emitter and detector have the same extent as the reaction lines, or are smaller, so as to minimise or substantially eliminate light entering the organic photodiode without passing through the reaction line.

### SUMMARY

According to a first aspect of the invention there is provided a reading device for a lateral flow test strip. The reading device includes a sample receiving volume disposed between first and second faces spaced apart in a first direction. The sample receiving volume is configured to receive at least a portion of a lateral flow test strip between the first and second faces such that a longitudinal axis of the lateral flow test strip is aligned in a second direction transverse to the first direction. The reading device also includes a light emitter arranged to illuminate a reading portion of the sample receiving volume. The reading device also includes a photodetector arranged to receive light from the reading portion. A width of the reading portion in the second direction is greater than a width of a test region of the lateral flow test strip in the second direction.

The photodetector may be arranged to receive light transmitted through the reading portion. The photodetector may be arranged to receive light reflected from the reading portion. The light may be reflected in an off-axis geometry. The light may be reflected in a confocal geometry. The photodetector may be arranged to receive fluorescence light emitted within the reading portion in response to illumination by the light emitter.

The light emitter may be arranged to emit light, in the first direction, through the reading portion of the sample receiving volume, and the photodetector may be arranged to receive light transmitted through the reading portion.

The first face may be a face of a first light blocking substrate which includes a first aperture, or the first face may be a face of a first transparent substrate supporting the light emitter. The second face may be a face of a second light blocking substrate which includes a second aperture, or the second face may be a face of a second transparent substrate supporting the photodetector.

The first face may be a face of a first light blocking substrate which includes a first aperture. The second face may be a face of a second light blocking substrate which includes a second aperture. The first and second apertures may be co-extensive and may face each other across the sample receiving volume to define the reading portion.

The first face may be a face of a first transparent substrate supporting the light emitter. The second face may be a face of a second transparent substrate supporting the photodetector. The light emitter and the photodetector may be co-extensive and may face each other across the sample receiving volume to define the reading portion.

The light emitter may be arranged to emit light at a first angle to the second direction. The photodetector may be arranged to receive light reflected from the reading portion at a second angle. The reading device may also include a first light blocking member, or a first portion of a light blocking member, including a first aperture which is arranged between the light emitter and the sample receiving volume to define the reading portion. The reading device may also include a second light blocking member, or a second portion of the light blocking member, including a second aperture which is arranged between the sample receiving volume and the photodetector.

The light emitter may include one or more light emitters and the photodetector may include one or more photodetectors. The one or more light emitters and the one or more photodetectors may be at least co-extensive with the reading portion.

The light emitter may include an array of inorganic light-emitting diodes or an array of organic light-emitting diodes.

The light emitter may take the form of a single, uniformly emissive organic light-emitting diode.

The photodetector may include an array of inorganic photodiodes or an array or organic photodiodes.

The photodetector may include a single, uniformly sensitive organic photodiode.

The width of the reading portion in the second direction may be greater than or equal to two times the width of the test region of the lateral flow test strip in the second direction.

The width of the reading portion in the second direction may be greater than or equal to one and a half times the width of the test region, or greater than or equal to three times the width of the test region.

The width of the reading portion in the second direction may be greater than or equal to 2 mm. The width of the reading portion in the second direction may be greater than or equal to 1.5 mm, or greater than or equal to 3 mm. The width of the reading portion in the second direction may be greater than or equal to 0.8 mm.

The width of the reading portion in the second direction may be less than or equal to five times the width of the test region of the lateral flow test strip in the second direction. The width of the reading portion in the second direction may be less than or equal to ten times the width of the test region of the lateral flow test strip in the second direction.

The width of the reading portion in the second direction may be less than or equal to 5 mm. The width of the reading portion in the second direction may be less than or equal to 10 mm.

The width of the reading portion in the second direction may be between 0.8 mm and 2.5 mm. The width of the reading portion in the second direction may be between 1.5 mm and 5 mm.

A lateral flow test device may include one or more reading devices, and a lateral flow test strip comprising one or more test regions. The longitudinal axis of the lateral flow test strip may be aligned parallel with the second direction. Each test region of the lateral flow test strip may be disposed within the reading portion of a corresponding reading device.

The lateral flow test strip may also include one or more control regions. Each control region of the lateral flow test strip may be disposed within the reading portion of a corresponding reading device.

### BRIEF DESCRIPTION OF THE DRAWINGS

Certain embodiments of the present invention will now be described, by way of example, with reference to FIGS. 4 to 13 and 15 of the accompanying drawings in which:

FIG. 1 illustrates a transmittance based reading device having a narrow reading portion, which is useful for understanding the present invention;

FIG. 2 illustrates measuring a peaked transmission profile of a test region of a lateral flow test strip;

FIG. 3 illustrates measuring a skewed transmission profile of a test region of a lateral flow test strip;

FIG. 4 illustrates a first reading device having a wide reading portion;

FIG. 5 illustrates measuring a peaked transmission profile of a test region of a lateral flow test strip using the first reading device;

FIG. 6 illustrates measuring a skewed transmission profile of a test region of a lateral flow test strip using the first reading device;

FIG. 7 illustrates a second reading device having a wide reading portion;

FIG. 8 is a graph comparing normalised transmission profiles of a lateral flow test strip corresponding to reading devices having wide and narrow reading portions;

FIG. 9 is a graph of changes in measured absorbance as a function of positional errors for the transmission profiles shown in FIG. 8;

FIG. 10 is a graph of organic photodiode (OPD) current profiles corresponding to reading devices having wide and narrow reading portions;

FIG. 11 is a graph of normalised transmission profiles calculated based on the OPD current profiles shown in FIG. 10;

FIG. 12 shows further details of the graph shown in Figure ii;

FIG. 13 illustrates a lateral flow test device incorporating a reading device;

FIG. 14 illustrates a reflectance based reading device having a narrow reading portion, which is useful for understanding the present invention; and

FIG. 15 illustrates a third reading device having a wide reading portion.

### DETAILED DESCRIPTION OF CERTAIN EMBODIMENTS

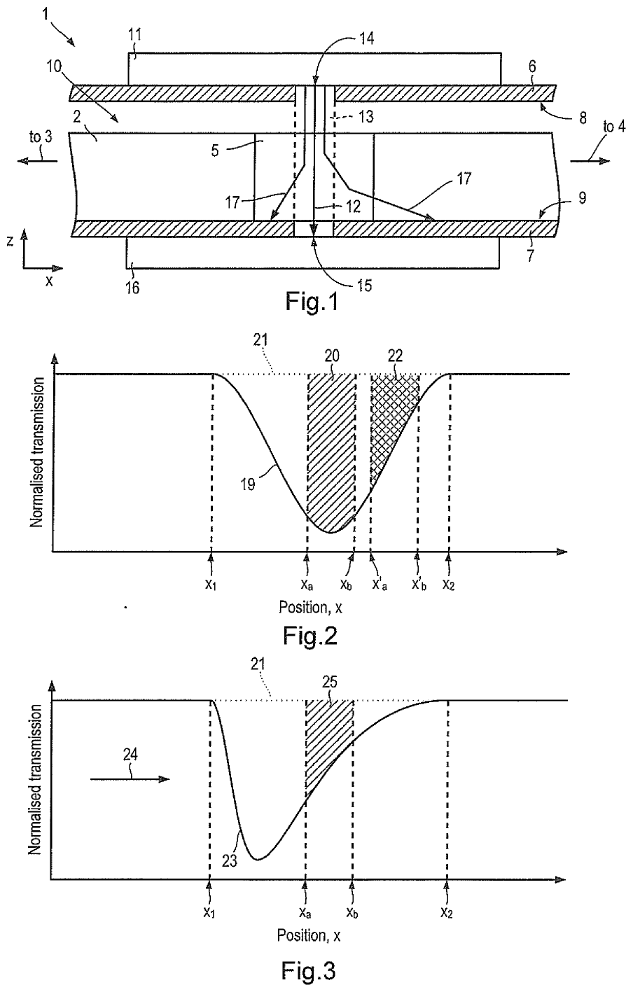

FIG. 1 shows a transmittance based reading device 1 for lateral flow strips 2, which is useful for understanding the present invention.

Lateral flow test strips 2 (also known as “lateral flow immunoassays”) are a variety of biological testing kit. Lateral flow test strips 2 may be used to test a liquid sample, such as saliva, blood or urine, for the presence of an analyte. Examples of lateral flow devices include home pregnancy tests, home ovulation tests, tests for other hormones, tests for specific pathogens and tests for specific drugs.

In a typical lateral flow test strip 2, a liquid sample is introduced at a first end 3 of a porous strip, which is typically formed using fibrous materials such as nitroceluulose, and the liquid sample is then drawn along the lateral flow test strip 2 towards a second end 4 by capillary action (or “wicking”). A typical lateral flow test strip 2 extends between the first and second ends 3, 4 in a longitudinal direction x. A portion of the lateral flow strip 2 is pre-treated with labelling particles which are activated with a reagent which binds to the analyte to form a complex if the analyte is present in the liquid sample. The bound complexes, and also unreacted labelling particles continue to propagate along the lateral flow test strip 2 before reaching a test region 5 which is pre-treated with an immobilised binding reagent which binds complexes of analyte bound to labelling particles and does not bind unreacted labelling particles. The labelling particles have a distinctive colour, or otherwise absorb one or more ranges of ultraviolet, visible of infrared light. The development of a concentration of labelling particles in the test region 5 may be measured and quantified using the transmittance based reading device 1, for example by measuring the optical density of labelling particles. The transmittance based reading device 1 may perform measurements on developed lateral flow test strips 2, i.e. the liquid sample has been left for a pre-set period to be drawn along the test strip 2. Alternatively, the analytical test device 1 may perform kinetic, i.e. dynamic time resolved measurements of the optical density of labelling particles.

The transmittance based reading device 1 includes first and second planar light blocking members 6, 7, each of which extends in first and second directions x, y. The first and second planar members 6, 7 are spaced apart in a third direction z, so that first and second opposed faces 8, 9 of the respective first and second members 6, 7 define a sample receiving volume 10 between them. The sample receiving volume 10 is configured to receive at least a portion of the lateral flow test strip 2 between the first and second faces 8, g such that the longitudinal axis of the lateral flow test 2 is aligned in the first direction x and transverse to the third direction z. For example, the sample receiving volume 10 may be configured to allow a lateral flow test strip 2 to pass entirely through. Alternatively, the sample receiving volume 10 may have a closed terminal end (not shown), such that a lateral flow test strip 2 inserted into the sample receiving volume can only be inserted until it abuts against the closed terminal end (not shown).

The transmittance based reading device 1 also includes a light emitter 11 arranged to emit light 12 through a reading portion 13 of the sample receiving volume 10. The light emitter 11 is arranged so as to emit the light substantially in the third direction z, i.e. through the thickness of the lateral flow test strip 2. In the transmittance based reading device 1, the reading portion 13 is defined by a first aperture 14 formed through the first light blocking member 6 so as to block light 12 from the light emitter 11 except in the reading portion 13. The reading portion 13 is further defined by a second aperture 15 formed through the second light blocking member 7 and on the opposite side of the sample receiving volume 10 to the first aperture 14. The transmittance based reading device 1 also includes a photodetector 16 arranged to oppose the light emitter 11 across the sample receiving volume 10. The second aperture 15 permits light 12 which passes substantially straight through the sample receiving volume 10 to reach the photodetector 16, but prevents light 17 scattered to significantly different angles from reaching the photodetector 16.

The absorbance due to labelling particles bound within the test region 5 may be determined in a number of ways. For example, by comparing the photodetector 16 signal measured for the test region 5 before and after conducting the assay, or by comparing the photodetector 16 signal measured for the test region 5 with the photodetector 16 signal for a blank region of the lateral flow test strip 2.

Transmittance based reading devices 1 for lateral flow test strips 2 have typically been designed to include first and second apertures 14, 15 having a width in the first direction x which is less than or, at most equal to, the width of a test region 5 when a lateral flow test strip 2 is received with the longitudinal axis aligned parallel to the first direction x. Using a narrow reading portion 13 defined in this way allows the contrast of measured signal to be maximised, and has been considered to improve the signal-to-noise ratio of the transmittance based reading device 1. Herein, the term “contrast” refers to a ratio between the peak photodetector 11 signal measured corresponding to the test region 5 and either the background signal measured corresponding to blank regions of the lateral flow test strip 2, or the background signal measured corresponding to the test region 5 prior to conducting the assay. For example, when the photodetector 16 is a photodiode, the signal is photodiode current. In this case, the contrast of the transmittance based reading device 1 takes the form of a relative change of the photodiode current due to light absorption in the test region 5, as compared to the photodiode current measured at a point away from the test region 5 or measured through the test region 5 prior to conducting the assay.

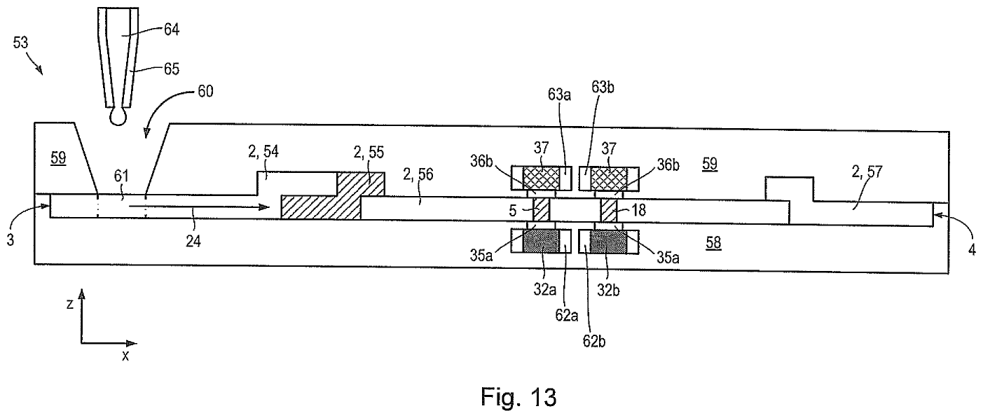

In order to obtain accurate and reproducible readings, the reading portion 13 needs to be aligned with the test regions 5 and/or any control regions 18 (FIG. 13). The precision and reproducibility of the alignment may be limited by a number of factors which include, but are not limited to:
deposition positioning errors when forming the test regions 5 and/or control regions 18 (FIG. 13);
lateral flow test strip 2 length variations arising from cutting errors when cutting the (typically fibrous) material of the lateral flow test strip 2 to size;
placement errors and/or movement freedom of the lateral flow test strip 2 within a plastic casing or cassette; and
stretching, bending and/or warping of the porous strip of the lateral flow test strip 2 which arises from of wetting with a liquid sample.

These sources of errors may result in up to ±0.5 mm positioning/alignment error in total, which is comparable to the typical 1 mm width of a test region 5 or control region 18 (FIG. 13).

The sensitivity of the transmittance based reading device 1 to such alignment errors of the lateral flow test strip 2 within the sample receiving volume 10 depends generally on the shape of the transmittance profile of the test region 5 once the assay has been conducted. While idealised lines with rectangular or “top hat” transmittance profile shapes would be expected to be less sensitive to alignment errors, in practical circumstances the (post assay) transmittance profile of a test region 5 or control region 18 (FIG. 13) does not resemble an idealised top-hat profile.

For example, referring also to FIG. 2, a normalised transmission profile 19 of a test region 5 is illustrated. A lower transmission through the test region 5 corresponds to a higher absorbance by labelling particles bound within the test region 5.

In practical circumstances, the distribution of labelling particles bound within a test region 5 will typically produce a transmission profile 19 having a peak. Such a peaked transmission profile 19 can be very sensitive to any positioning/alignment errors.

In the example illustrated in FIG. 2, the test region 5 extends in the first direction x between a pair of points x₁ and x₂, taking the origin of the coordinates to be attached to the lateral flow test strip 2. When the lateral flow test strip 2 is perfectly aligned within the sample receiving volume 10, the first and second apertures 14, 15 define a reading portion 13 which is centred on the test region 5 and which extends in the first direction x between a pair of points xₐ, x_{b} satisfying x_{b}−xₐ≤x₂−x₁. When the lateral flow test strip 2 is ideally aligned in this way, the photodetector 16 will produce a signal which is related to a first accumulated difference zo between the transmission profile 19 within the reading portion 13 and a reference signal level 21 corresponding to a blank region to either side of the test region 5 or to the test region 5 before conducting the assay.

However, when the positioning of the test region 5 with respect to the reading portion 13 is off-centre, for example when the reading portion 13 lies between the points x′ₐ and x′_{b} in the first direction x (the origin of coordinates being attached to the lateral flow test strip for the purposes of FIG. 2), then the photodetector 16 will produce a signal which is related to a second accumulated difference 22 which is smaller than the first accumulated difference 21. This difference arises from the peak shape of the transmission profile 19.

Furthermore, the shape of the transmission profile of a test region may be asymmetric. For example, referring also to FIG. 3 a skewed transmission profile 23 is illustrated.

The symmetry or otherwise of the transmission profile of a test region 5 (after conducting an assay) may depend on the analyte concentration. For example, labelling particles such as gold or latex nanoparticles may have a higher probability of being bound towards the nearest side of the test region 5 relative to a flow direction 24. In this way, even when the lateral flow test strip 2 is ideally aligned with the reading portion 13 of the transmittance based reading device 1, the photodetector 16 may produce a signal which is related to a third accumulated difference 25 which does not register the actual peak absorbance within the test region 2.

Reading devices 1 including reading portions 13 which are narrower than the test regions 5 and/or control regions 18 (FIG. 13) of lateral flow test strips 2 have been employed because the use of a narrow reading portion 13 may minimize or completely eliminate the light from the light emitter 11 which enters the photodetector 16 without passing through the test region 5. In this way, the contrast relative to the background absorbance of the lateral flow test strip 2 may be maximised, which has been considered to be beneficial to the signal-to-noise ratio of a transmittance based reading device 1. However, as described hereinbefore, the high contrast comes at the expense of sensitivity to alignment/positioning errors of the lateral flow test strip 2 within the sample receiving volume.

The present specification is concerned with the problem of improving the tolerance of reading devices for lateral flow test strips 2 to alignment/positioning errors of the lateral flow test strip 2. The present specification is also concerned with the problem of improving the signal-to-noise ratio of a transmittance based reading device 1, which may be limited by low photodetector 11 signals resulting from low optical transmittance of a lateral flow test strip 2 and a relatively small area of the reading portion 13. Local transmission fluctuations resulting from the variable density of fibrous materials forming the lateral flow test strip 2 may also add background noise and contribute to the output signal-to-noise ratio of a transmittance based reading device 1.

The positioning/alignment problem has previously been addressed by trying to improve the accuracy of aligning test regions 5 and/or control regions 18 (FIG. 13) within the reading portion 13. However, some sources of error, in particular shape changes of the lateral flow test strip 2 upon wetting with a liquid sample, are difficult to account for in advance. Transmission profile shape variations, for example a skewed transmission profile 23, have often not been taken into account. The problem of low photodetector 16 current signals has typically been addressed by driving light emitters 11 at high luminance in combination with the use of sensitive electronics to measure low photodetector 16 signals. However, when the light emitter 11 is an organic light emitting diode (OLED), driving at high luminance, i.e. high currents, may result in accelerated degradation of the OLED. Highly sensitive electronics may be costly and/or bulky, neither of which is well suited to integration into a single use lateral flow test device.

### First Reading Device

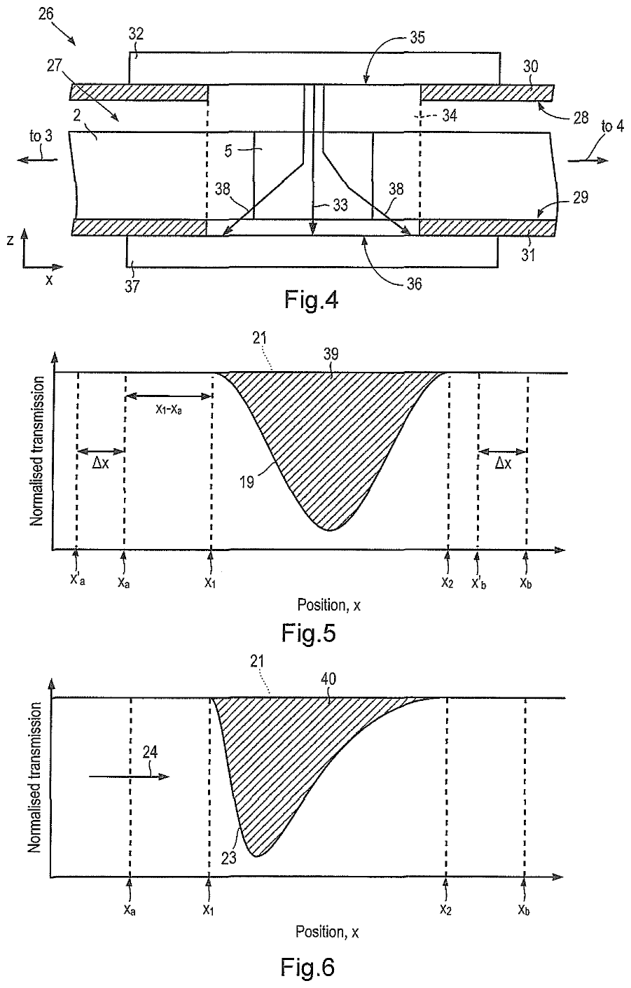

Reading devices according to the present invention have been designed to address the problems of lateral flow test strip 2 positioning/alignment and low photodetector signals in a new way. In particular, reading devices according to the present invention include reading portions 34 (FIG. 4) which are configured to be wider, or significantly wider, than the width of test and/or control regions 5, 18 (FIG. 13) of a lateral flow strip 2 parallel to the longitudinal axis of a lateral flow test strip 2. As shall be described hereinafter, the inventors have found that despite the expected reduction in signal contrast, the signal-to-noise ratio may be surprisingly improved.

Referring to FIG. 4, a first reading device 26 for a lateral flow test strip 2 is shown.

The first reading device 26 includes a sample receiving volume 27 defined by first and second parallel faces 28, 29 spaced apart in the third direction z. In this example, the first and second parallel faces 28, 29 are provided by corresponding first and second planar light blocking substrates 30, 31. The sample receiving volume 27 is configured to receive at least a portion of a lateral flow test strip 2 between the first and second faces 28, 29, such that a longitudinal axis of the lateral flow test strip is aligned in a direction substantially perpendicular to the third direction z. For example, the lateral flow test strip 2 may be received with its longitudinal axis aligned in the first direction x. The sample receiving volume 27 may be configured to allow a lateral flow test strip 2 to pass entirely through. Alternatively, the sample receiving volume 27 may have a closed terminal end (not shown), such that a lateral flow test strip 2 inserted into the sample receiving volume can only be inserted until it abuts against the closed terminal end (not shown). The spacing of the first and second faces 28, 29 may be larger than a thickness of a lateral flow test strip 2. However, there is preferably no, or minimal, gap between a received lateral flow test strip 2 and the first and second faces 28, 29. The size of the gap between the first and second faces 28, 29 may be variable to accommodate lateral flow test strips 2 having a range of different thicknesses.

The first reading device 26 includes a light emitter 32 arranged to emit light 33 through a reading portion 34 of the sample receiving volume 27. The light emitter 32 is arranged so as to emit the light 33 substantially in the third direction z, i.e. through the thickness of the lateral flow test strip 2. In the first reading device 26, the reading portion 34 is defined by a first aperture 35 formed through the first light blocking substrate 30 so as to block light 33 from the light emitter 32 except in the reading portion 34. The reading portion 34 is further defined by a second aperture 36 formed through the second light blocking substrate 31 and on the opposite side of the sample receiving volume 27 to the first aperture 35. The first reading device 26 also includes a photodetector 37 arranged to opposed the light emitter 32 across the sample receiving volume 27. The second aperture 36 permits light 33 which passes substantially through the sample receiving volume 27 to reach the photodetector 37.

The difference between the first reading device 26 and the transmittance based reading device x is that, in the first reading device 26, a width of the reading portion 34 in the direction perpendicular to the third direction z is greater than a width of a test region 5 parallel to the longitudinal axis of a lateral flow test strip 2. For example, if the lateral flow test strip 2 is received with its longitudinal axis parallel to the first direction x such that the test region 5 lies between a pair of points x₁, x₂, then the reading portion 34 of the first device 26 spans between a pair of points xₐ, x_{b} satisfying xₐ−x_{b}<x_{b}−xₐ. Consequently, in contrast to the transmittance based reading device 1, the apertures 35, 36 may be wide enough to permit light 38 scattered to significantly different angles within the test region 5 to reach the photodetector 37 and be detected.

Referring also to FIG. 5, the normalised transmission profile 19 is schematically illustrated with reference to the first reading device 26.

When the absorbance of a test region 5 is measured using the first reading device 26, the reading portion 34 wider than the test region 5 means that the photodetector 37 will produce a signal which is related to a fourth accumulated difference 39 between the transmission profile 19 within the reading portion 34 and the reference signal level 21. The fourth accumulated difference 39 is larger than even the first accumulated difference 20 corresponding to ideal alignment of the transmittance based reading device 1 having a narrow reading portion 13. Moreover, even if the test region 5 is not centrally aligned within the reading portion 34, the tolerance of the first reading device 26 reduces or avoids signal variations from positioning/alignment errors. For example, if the lateral flow test strip 2 is imperfectly aligned so that the reading portion 34 extends between pair of points x′ₐ, x′_{b} (with the origin of coordinates attached to the lateral flow test strip 2 for the purposes of FIG. 5) which are offset from the points xₐ, x_{b} (corresponding to central alignment) by an offset distance dx, then the accumulated difference will remain substantially unchanged until the offset distance dx exceeds an amount x₁−xₐ.

Referring also to FIG. 6, the skewed transmission profile 23 is schematically illustrated with reference to the first reading device 26.

When the absorbance of a test region 5 is measured using the first reading device 26, the reading portion 34 wider than the test region 5 means that the photodetector 37 will produce a signal which is related to a fifth accumulated difference 40 between the skewed transmission profile 23 within the reading portion 34 and a reference signal level 21. The fifth accumulated difference 40 is larger than the third accumulated difference 25 corresponding to ideal alignment of the transmittance based reading device 1 having a narrow reading portion 13. Moreover, it may be observed that using the first reading device 26, a skew of the transmission profile will not alter the measured signal, because the photodetector 37 signal takes account of the entire test region 5.

Test regions 5 and control regions 18 (FIG. 13) of lateral flow test strips 2 are typically of the order of 1 mm wide. When the first reading device 26 is not directly integrated into a lateral flow test device (FIG. 13), for example if the first reading device 26 is a benchtop reader, the width of the reading portion 34 may be set to be wider than the test regions 5 of standard or commonly used lateral flow test strips 2. When the first reading device 26 is directly integrated into a lateral flow test device, the width of the test region 5 and/or control region 18 (FIG. 13) to be measured is known, and the width of the reading portion 34 may be set accordingly.

The width of the reading portion 34 in a direction parallel to the longitudinal axis of a lateral flow test strip 2 received in the sample receiving volume 27 may be greater than or equal to two times the width of a test region 5 and/or control region 18 (FIG. 13). The width of the reading portion 34 in a direction parallel to the longitudinal axis of a received lateral flow test strip 2 may be less than or equal to five times the width of a so test region 5 and/or control region 18 (FIG. 13) in the same direction. The width of the reading portion 34 in a direction parallel to the longitudinal axis of a received lateral flow test strip 2 may be between two and five times the width of a test region 5 and/or control region 18 (FIG. 13).

For example, test regions 5 and control regions 18 (FIG. 13) of lateral flow test strips 2 are typically of the order of 1 mm wide. Thus, a general purpose first reading device 26 may include a reading portion 34 having a width of greater than or equal to 2 mm, and less than or equal to 5 mm. Other specific dimensions may be used in dependence upon of the width of test regions 5 and/or control regions 18 (FIG. 13) of the lateral flow test strips 2 to be measured. For example, in the case of a test region 5 of 0.5 mm width combined with special precautions for accurately positioning the test strip 2 within a cassette (not shown), a reading portion 34 of 0.8 mm width may be used.

The light emitter 32 may take the form of one or more light emitters and the photodetector 37 may take the form of one or more photodetectors. In the first reading device 26, the one or more light emitters 32 and the one or more photodetectors 37 are at least co-extensive with the reading portion 34.

The light emitter 32 may take the form of a planar array of inorganic light-emitting diodes or a planar array of organic light-emitting diodes. Preferably, the light emitter 32 may take the form of a single, uniformly emissive organic light-emitting diode (OLED). A single OLED which provides the light emitter 32 should be at least co-extensive with the reading portion 34.

The photodetector 37 may take the form of a planar array of inorganic photodiodes or a planar array or organic photodiodes. Preferably, the photodetector 37 may take the form of a single, uniformly sensitive organic photodiode (OPD). A single OPD which provides the photodetector 37 should be at least co-extensive with the reading portion 34.

The first reading device 26 addresses the problem of errors in aligning/positioning a lateral flow test strip 2 relative to the reading portion 34 by making the width of the reading portion 34 larger than the width of a test region 5 or control region 18 (FIG. 13) parallel to the longitudinal axis of the lateral flow test strip 2. Making the reading portion 34 relatively wider inherently reduces the signal contrast relative to a reference signal level 21, which previously might have been expected to reduce the quality of the photodetector 16 signal by reducing the signal-to-noise ratio. However, it has been surprisingly found that the signal-to-noise ratio using relatively wide reading portions 34 is increased overall. As described hereinafter, this improvement is thought to result from a combination of higher photodetector current and smoothing of transmission fluctuations which result from localised variability in the density of the fibrous materials which form the porous strip of a lateral flow test strip 2. These effects may be enough to offset a reduction in signal-to-noise ratio arising from the reduction in signal contrast.

### Second Reading Device

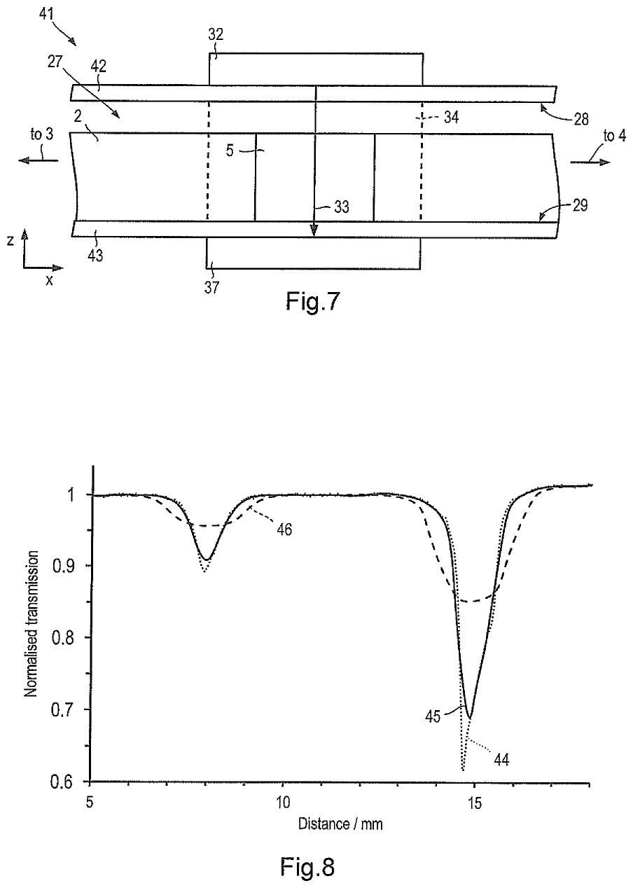

Referring also to FIG. 7, a second reading device 41 is shown.

The second reading device 41 is the same as the first reading device 26, except that reading portion 34 is not defined by apertures 35, 36 through planar light blocking substrates 30, 31. In the second reading device 41, the first face 28 defining the sample receiving volume 27 is a face of a first transparent substrate 42 which supports the light emitter 32 on the opposed planar face. Similarly, the second face 29 defining the sample receiving volume 27 is a face of a second transparent substrate 43 which supports the photodetector 37 on the opposed planar face. The light emitter 32 and photodetector 37 are each planar, for example the light emitter 32 may take the form of a single OLED deposited onto the first transparent substrate 42 and the photodetector 37 may take the form of a single OPD deposited onto the second transparent substrate 43. The light emitter 32 and photodetector 37 are co-extensive and face each other across the sample receiving volume 27 to define the reading portion 34.

Alternatively the light emitter 32 may take the form of two or more light emitters and/or the photodetector 37 may take the form of two or more photodetectors. In any event, in the second reading device 41 the light emitter(s) 32 and the photodetector(s) 37 define and are co-extensive with the reading portion 34.

### Improvement of Reading Device Tolerance to Positioning Errors

The potential improvement in tolerance to alignment/positioning errors was analysed using data obtained from an exemplary lateral flow test strip 2 in the form of a BioPorto (RTM) generic rapid assay device. The exemplary lateral flow test strip 2 was formed from nitrocellulose and included a testing region 5 and a control region 18 (FIG. 13). The exemplary lateral flow test strip 2 was developed using a liquid sample containing a target analyte in the form of troponin prior to obtaining measurements. The labelling particles were gold nanoparticles.

Referring also to FIG. 8, an experimentally measured transmission profile 44 of the exemplary lateral flow test strip 2 is compared against transmission profiles 45, 46 calculated using 0.5 mm and 2.0 mm boxcar averaging.

The measured transmission profile 44 was obtained from image analysis of the exemplary lateral flow test strip 2. The 0.5 mm transmission profile 45 was calculated based on boxcar averaging the measured transmission profile 44 using a 0.5 mm wide window. The boxcar averaging approximates the signal expected if the exemplary lateral flow test strip 2 was scanned using a relatively narrow reading portion 13 of 0.5 mm width. Similarly, the 2.0 mm transmission profile 46 was calculated based on boxcar averaging the measured transmission profile 44 using a 2.0 mm wide window corresponding to a relatively wide reading portion 34.

Two regions of interest may be observed in the measured transmission profile 44. The first, between about 7 to 9 mm distance, corresponds to the test region 5 of the exemplary lateral flow test strip 2. The second, between about 14 to 16 mm, corresponds to the control region 18 (FIG. 13) of the exemplary lateral flow test strip 2. It may be observed that the test and control regions 5, 18 (FIG. 13) both display “peak” rather than “top hat” profile shapes. Consequently, the 0.5 mm transmission profile 45, approximating the output of a transmittance based reading device 1 having a relatively narrow reading portion 13 (compared to the test/control regions 5, 18), would be sensitive to positioning/alignment errors as described hereinbefore. It may be observed from the 2.0 nm transmission profile 46 that use of a reading device 26, 41 including a relatively wide reading portion 34 (compared to the test/control regions 5, 18) reduces the amplitude of the decrease in transmission, i.e. the signal contrast, by a factor of approximately two as compared to the 0.5 mm transmission profile 44. However, the 2.0 mm transmission profile 46 may be observed to display an increased effective “width” of the peaks corresponding to the test region 5 and control region 18 (FIG. 13). In this way, it may be inferred that a first reading device 26 having a 2 mm wide reading portion 34 may be less sensitive to positional/alignment errors.

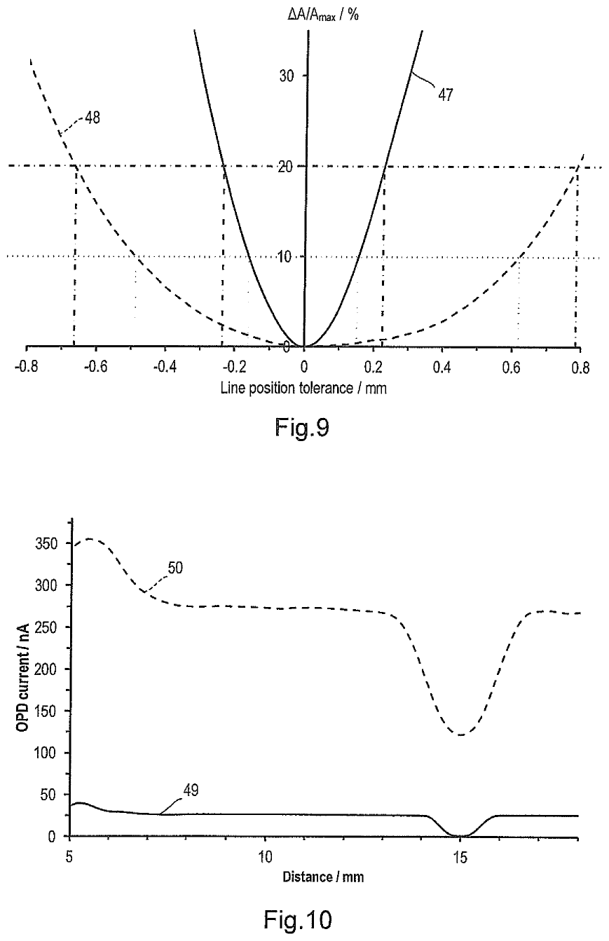

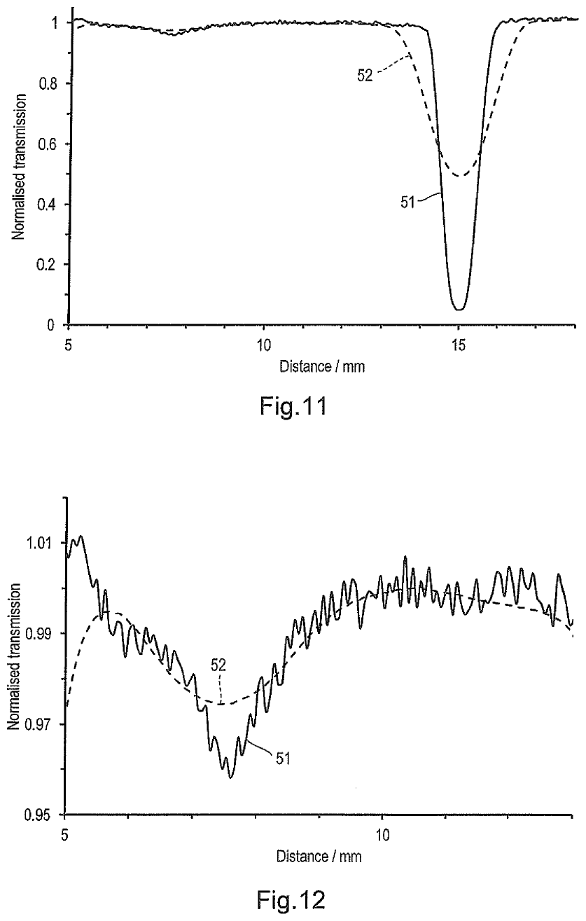

Referring also to FIG. 9, absorbance change profiles 47, 48 corresponding to the 0.5 mm and 2.0 mm transmission profiles 45, 46 are shown as a function of positional error.

In order to quantify the dependence of a reading device 26, 41 on positioning/alignment errors, absorption variations ΔA/Aₘₐₓ were calculated, in which Aₘₐₓ is the peak absorbance, ΔA is a change in absorbance when offset from centre, and the absorbance A is related to transmittance T according to A=1−T. The 0.5 mm absorbance change profile 47 corresponds to the 0.5 mm transmission profile 45 and the 2.0 mm absorbance change profile 48 corresponds to the 2.0 mm transmission profile 46. The absorbance change profiles 47, 48 shown in FIG. 9 correspond to the test region 5 peak between about 7 to 9 mm in FIG. 8, and the absorbance change profiles 47, 48 are plotted as a function of displacement from the centre of the test region 5.

It may be observed that the wide absorbance change profile 48 shows a roughly three times increase of the alignment error which may be tolerated before the reading device 1, 26, 41 exceeds a 10% or 20% measurement error, as summarised in Table 1:

TABLE 1

| | Test region alignment | Test region alignment |
|---|---|---|
| Measurement | tolerance | tolerance |
| error | (narrow = 0.5 mm) | (narrow = 2.0 mm) |
| 10% | <340 μm | <1.1 mm |
| 20% | <490 μm | <1.5 mm |

### Signal-to-Noise Ratio Improvement

As described hereinbefore, the first or second reading devices 26, 41 reduce the signal contrast of a test region 5 or control region 18 (FIG. 13) with respect to the blank regions of the lateral flow test strip 2.

However, despite this reduction in contrast, it has been surprisingly found that reading devices 26, 41 having reading portions 34 wider than test regions 5 and/or control regions 18 (FIG. 13) of a lateral flow test strip 2 may exhibit improved overall signal-to-noise ratio in the photodetector 37 output.

Reading devices 1 having a reading portion 13 narrower than test regions 5 and/or control regions 18 (FIG. 13) of a lateral flow test strip 2 may exhibit low photodetector signal levels as a result of low optical transmittance of typical lateral flow test strips 2, a small illumination area corresponding to a relatively narrow reading portion 13 (compared to test/control regions 5, 18), and strong light scattering within the lateral flow test strip 2. For example, referring again to FIG. 1, a fraction of the test region 5 intersecting the reading portion 13 is illuminated, and a proportion of the light 12 incident on the test region 5 is lost as scattered light 17 which never reaches the photodetector 16. The scattered light 17 represents light scattered by the fibrous material of the lateral flow test strip 2, rather than absorbed or reflected by labelling particles bound within the test region 5.

Typically, law photodetector signal levels may be addressed by driving the light emitter 11 at a high luminance. This may be problematic when, for example, it is desired to use a light emitter 11 in the form of an OLED coupled with a photodetector 16 in the form of an OPD. At reasonably high OLED brightness, for example corresponding to ˜1000 cd/m² for a green coloured OLED, OPD current corresponding to a test or control region 5, 18 without labelling particles such as gold nanoparticles may be as low as ˜10 nA. In order to be able to resolve changes of transmission of, for example, 0.1% at such current levels, it is necessary to measure OPD current with a precision of 10 pA. This level of current sensitivity may be difficult to implement in practice, and may require complex, expensive and/or bulky measurement electronics. Attempting to increase the OPD current by driving the OLED at a higher luminance may not be a practical solution, since this is likely to result in more rapid OLED degradation. Rapid OLED degradation may also reduce the accuracy of measurements performed using the transmittance based reading device 1.

By contrast, the relatively wider reading portions 34 (relative to the test/control regions 5, 18) of the first and second reading devices 26, 41 may increase the detected signal in two ways. Firstly, the entire test region 5 is illuminated. Secondly, a larger amount of scattered light 38 may be detected by the photodetector 37, since the reading portion 34 extends to either side of the test region 5. Consequently, the photodetector 37 signal level is generally increased for the first or second reading device 26, 41, which may enable resolution of smaller changes in the optical transmission of test/control regions 5, 18 (FIG. 13). It has been surprisingly found that this may result in improvement of the overall signal-to-noise ratio of the reading device 26, 41, by offsetting a reduction of signal-to-noise ratio resulting from the decrease in the signal contrast.

Referring also to FIG. 10, OPD current output profiles 49, 50 are plotted as a function of distance along a lateral flow test strip 2 for an example of the reading device including apertures 14, 15 with a width of 0.4 mm and an example of the first reading device 26 including apertures 35, 36 with a width 21 mm.

The OPD current profiles 49, 50 were obtained by scanning a Bioporto lateral flow test strip 2 using reading devices 1, 26 in which the light emitter 11, 32 took the form of a single, uniform OLED and the photodetector 16, 37 took the form of a single, uniform OPD. The 0.4 mm OPD current profile 49 corresponds to an aperture 14, 15 width of 0.4 mm and the 2.1 mm OPD current profile 50 corresponds to an aperture 35, 36 width of 2.1 mm.

It may be observed the 2.1 mm OPD current profile 50 exhibits an increase of OPD current. It may also be surprisingly observed that the current increase is of the order of ≈10 times, which exceeds the increase in area of the reading portion 13, 34 which is only of the order of ≈5 times. This surprising disparity is believed to be the result of the Jo strong scattering of light 12, 33 by the fibrous materials of the lateral flow test strip 2 into scattered light 17, 38, resulting in higher relative signal loss when the reading portion 13 is relatively small (compared to the test/control region 5, 18). Such improvements in photodetector 37 signal, which exceed the change in relative area of reading portion 13, 34, may contribute to improving the signal-to-noise ratio by offsetting any degradation of signal-to-noise rations which results from decreased signal contrast.

Referring also to Figure ii, normalised transmission profiles 51, 52 calculated based on the OPD current profiles 49, 50 are shown.

Referring also to FIG. 12, a section of the transmission profiles 51, 52 corresponding to the test region 5 is shown.

A 0.4 mm normalised transmission profile 51 corresponds to the 0.4 mm OPD current profile 49 and a 2.1 mm normalised transmission profile 52 corresponds to the 2.1 mm OPD current profile 50. It may be observed that the 2.1 mm normalised transmission profile 52 exhibits contrast reduced by a factor of approximately two. However, despite this, referring in particular to FIG. 12, it may be observed that the signal-to-noise ratio of the 2.1 mm normalised transmission profile 52 is nonetheless improved in contrast to the 0.4 mm normalised transmission profile.

Typical OPD current measurement noise level was of the order of 0.1 nA, which was limited by the current measurement device used. For the narrower reading portion 13 of 0.4 mm width, this corresponds to 0.4% of a 26 nA peak signal corresponding to the test region 5. For the wider reading portion 34 of 2.1 mm width, the noise of 0.1 nA corresponds to less than 0.04% of a 273 nA peak signal corresponding to the test region 5.

The observed improvements in signal-to-noise ratio may also result, in part, from effectively smoothing fluctuations in the background transmittance of the lateral flow test strip 2. Such background transmittance fluctuations arise from the innate local variability of fibrous materials used to form the lateral flow test strip 2.

### Lateral Flow Test Device Incorporating a Reading Device

One application of reading devices 26, 41 is to provide compact integration into a lateral flow test device which includes a lateral flow test strip 2 including one or more test regions 5 and, optionally, one or more corresponding control regions 18 (FIG. 13). The lateral flow test device also includes a reading device 26, 41 corresponding to each test region 5 and, optionally, each control region 18 (FIG. 13). The reading portion 34 of each reading device 26, 41 is arranged to accommodate the respective test or control region 5, 18.

For example, referring also to FIG. 13, the first reading device 26 may be integrated into a self-contained, single use lateral flow test device 53.

The lateral flow test device 53 includes a lateral flow test strip 2 divided into a sample receiving portion 54, a conjugate portion 55, a test portion 56 and a wick portion 57. The lateral flow test strip 2 is received into a base 58. A lid 59 is attached to the base 58 to secure the lateral flow test strip 2 and cover parts of the lateral flow test strip 2 which do not require exposure. The lid 59 includes a sample receiving window 60 which exposes part of the sample receiving portion 54 to define a liquid sample receiving region 61. The lid and base 58, 59 are made from a polymer such as, for example, polycarbonate, polystyrene, polypropylene or similar materials.

The base 58 includes a pair of recesses 62a, 62b, and a light emitter 32a, 32b in the form of a single, uniform OLED is received into each recess 62a, 62b. The lid 59 includes a corresponding pair of recesses 63a, 63b, and a photodetector 37a, 37b in the form of a single, uniform OPD is received into each recess 63a, 63b. The first pair of an OLED 32a and OPD 37a is arranged on opposite sides of a test region 5 of the lateral flow test strip 2. The second pair of an OLED 32b and OPD 32b is arranged on opposite sides of a control region 18 of the lateral flow test strip 5. The test region 5 and control region 18 each have a width of x₂−x₁=δxₗᵢₙₑ. First apertures 35a, 35b may be formed integrally from the material of the base 58. Alternatively, the first apertures 35aa, 35b may be defined using one or more light blocking members 30 (not shown in FIG. 13). The first apertures 35a, 35b extend transversely across the width of the lateral flow test strip 2. For example, if the lateral flow test strip 2 extends in a first direction x and has a thickness in a third direction z, then the first apertures 35a, 35b extend in a second direction y. The first apertures 35a, 35b each have a width of x_{b}−xₐ=δx_{read}, which satisfies δx_{read}>δxₗᵢₙₑ, and preferably satisfies, δx_{read}≥2·δxₗᵢₙₑ. The width δx_{read} of the first apertures 35a, 35b should generally not exceed five times that of the test/control regions 5, 18, i.e. δx_{read}≤5·δxₗᵢₙₑ. Similarly, the second apertures 36a, 36b may be formed either integrally from the lid 59 or using one or more light blocking members 31 (not shown in FIG. 13). The second apertures 36a, 36b have the same dimensions as the first apertures 35a, 35b.

The apertures 35a, 35b, 36a, 36b may be filled with, or covered over by, a layer of transparent material to prevent moisture entering into the recesses 62a, 62b, 63a, 63c, which might be deleterious to the OLEDs 32a, 32b and/or OPDs 32a, 32b. Material may be considered to be transparent to a particular wavelength λ if it transmits more than 75%, more than 85%, more than 90% or more than 95% of the light at that wavelength λ. A diffuser (not shown) may optionally be included between each OLED 32a, 32b and the corresponding first aperture 35a, 35b.

A liquid sample 64 is introduced to the sample receiving portion 54 through the sample receiving window 60 using, for example, a dropper 65 or similar implement. The liquid sample 64 is transported in the flow direction 24 towards the second end 4 by a capillary, or wicking, action of the porosity of the lateral flow test strip 54, 55, 56, 57. The sample receiving portion 54 of the lateral flow test strip 2 is typically made from fibrous cellulose filter material.

The conjugate portion 55 has been pre-treated with at least one particulate labelled binding reagent for binding an analyte which is being tested for, to form a labelled-particle-analyte complex (not shown). A particulate labelled binding reagent is typically, for example, a nanometre- or micrometre-sized label particle which has been sensitised to specifically bind to the analyte. The particles provide a detectable response, which is usually a visible optical response such as a particular colour, but may take other forms. For example, particles may be used which are visible in infrared, or which fluoresce under blue or ultraviolet light. Typically, the conjugate portion 55 will be treated with one type of particulate labelled binding reagent to test for the presence of one type of analyte in the liquid sample 64. However, lateral flow devices 53 may be produced which test for two or more analytes using two or more particulate labelled binding reagents concurrently. The conjugate portion 55 is typically made from fibrous glass, cellulose or surface modified polyester materials.

As the liquid sample 64 moves into the test portion 56, labelled-particle-analyte complexes and unbound label particles are carried along towards the second end 4. The test portion 56 includes a test region 5 measured and/or monitored by OLED 32a and OPD 37a, and a control region 18 measured and/or monitored by OLED 32b and OPD 37b.

The test region 5 is pre-treated with an immobilised binding reagent which specifically binds the label particle-target complex and which does not bind the unreacted label particles. As the labelled-particle-analyte complexes are bound in the test region 5, the concentration of the label particles in the test region 5 increases. The concentration increase may be monitored by measuring the absorbance of the test region 5 using the corresponding OLED 32a and OPD 37a. The absorbance of the test region 5 may be measured once a set duration has expired since the liquid sample 64 was added. Alternatively, the absorbance of the test region 5 may be measured continuously or at regular intervals as the lateral flow strip is developed.

To provide distinction between a negative test and a test which has simply not functioned correctly, a control region 18 is often provided between the test region 5 and the second end 4. The control region 18 is pre-treated with a second immobilised binding reagent which specifically binds unbound label particles and which does not bind the labelled-particle-analyte complexes. In this way, if the lateral flow test device 53 has functioned correctly and the liquid sample 64 has passed through the conjugate portion 55 and test portion 56, the control region 18 will exhibit an increase in absorbance. The absorbance of the control region 18 may be measured by the OLED 32b and OPD 37b in the same way as the test region 5. The test portion 56 is typically made from fibrous nitrocellulose, polyvinylidene fluoride, polyethersulfone (PES) or charge modified nylon materials.

The wick portion 57 provided proximate to the second end 4 soaks up liquid sample 64 which has passed through the test portion 56 and helps to maintain through-flow of the liquid sample 64. The wick portion 57 is typically made from fibrous cellulose filter material.

The lateral flow test device 53 may alternatively incorporate examples of the second reading device 41.

### Reflection Mode Reading Devices

The first and second reading devices 26, 41 may perform absorbance measurements based on light transmitted through the relatively wide reading portion 34 of the sample receiving volume 27. However, the concept of using a relatively wide reading portion 34 may also be applied to absorbance measurements based on light reflected from a sample.

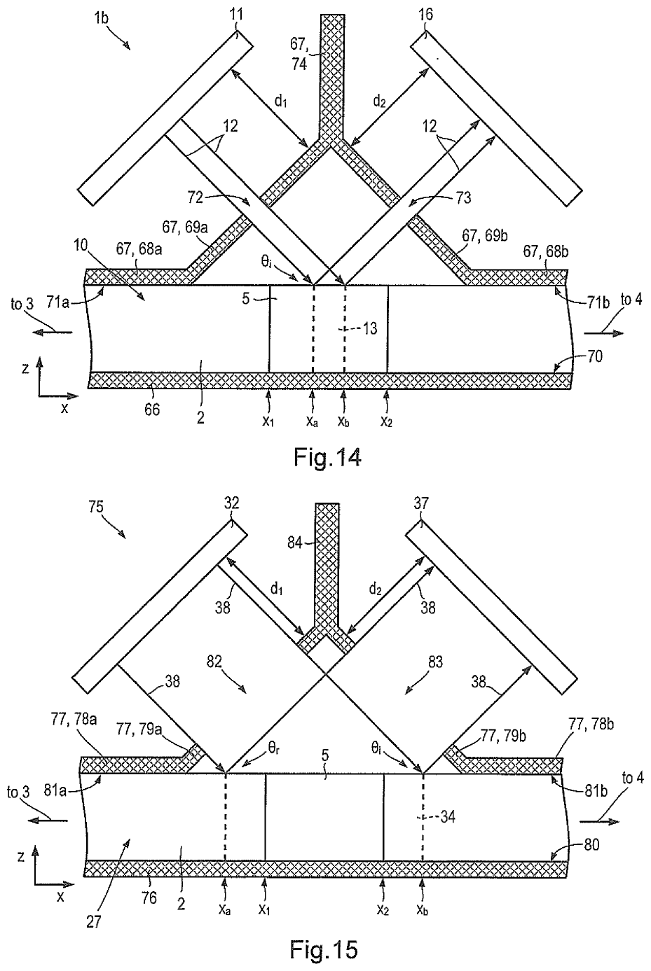

Referring also to FIG. 14, a reflectance based reading device 1b for lateral flow test strips 2 is shown. The reflectance based reading device 1b is useful for understanding the present invention.

The reflectance based reading device 1b includes a first light blocking member 66 which is planar and extends in first and second directions x, y. The reflectance based reading device 1b also includes a second light blocking member 67 which includes first and second planar portions 68a, 68b extending in first and second directions x, y, and arranged in the first direction x to either side of first and second aperture defining portions 69a, 69b. The planar portions 68a, 68b and the aperture defining portions 69a, 69b may be integrally formed as a single second light blocking member 67. The first light blocking member 66 and the planar portions 68a, 68b of the second light blocking member 67 are spaced apart in a third direction z, so that a first face 70 of the first light blocking members 66 is opposed to second faces 71a, 71b of the planar portions 68a, 68b of the second light blocking member 67, so as to define a sample receiving volume 10 between them. The sample receiving volume 10 is configured to receive at least a portion of the lateral flow test strip 2 between the first and second faces 70, 71a, 71b such that the longitudinal axis of the lateral flow test 2 is aligned in the first direction x and transverse to the third direction z. For example, the sample receiving volume 10 may be configured to allow a lateral flow test strip 2 to pass entirely through. Alternatively, the sample receiving volume 10 may have a closed terminal end (not shown), such that a lateral flow test strip 2 inserted into the sample receiving volume can only be inserted until it abuts against the closed terminal end (not shown).

The reflectance based reading device 1b also include a light emitter 11 arranged to emit light 12 at an incident angle θᵢ to the first direction x. The light emitter 11 is the same as the reading device 1, except for the geometric arrangement with respect to the sample receiving volume 10. When a lateral flow test device 2 is received within the sample receiving volume 10, the light 12 intersects a surface of the lateral flow test device 2 at the incident angle θ1. The relatively narrow reading portion 13 of the reflectance based reading device 1b is defined by a first aperture 72 through the first aperture defining portion 69a of the second light blocking member 67. The first aperture 72 is sized and positioned such that light 12 from the light emitter 11 intersects a lateral flow test strip 2 received within the sample receiving portion 10 between a pair of points xₐ, x_{b} in the first direction x. The pair of points xₐ, x_{b} define the extent of the reading portion 13. The first aperture 72 preferably extends for the width of a lateral flow test strip 2 in the second direction y, but may be narrower. The surface of a received lateral flow test strip 2 may lie in the plane containing the second planar portions 68a, 68b of the second light blocking member 67. Depending on the angular emission profile of light emitter 11, the light emitter n may be placed a distance d₁ from the first aperture 72 in order to provide effective collimation of the light 12 and to sharply define the narrow reading portion 13. When a lateral flow test strip 2 is received into the sample receiving volume 10 and the test region 5 is aligned centrally with respect to the reading portion 13, the test region 5 extends between a pair of points x₁, x₂ spaced apart in the first direction x. The width x_{b}−xₐ of the reading portion is less than or equal to the width x₂−x₁ of the test region 5, i.e. x_{b}−xₐ≤x₂−x₁.

The reading device 1b also includes a photodetector 16 arranged to receive light 12 reflected from the reading portion 13. The reflected light 12 reaches the photodetector 16 through a second aperture 73 through the second aperture defining portion 69b of the second light blocking member 67. The second aperture 73 is arranged to restrict the light 12 received to light which is scattered to a reflected angle θᵣ within the reading portion 13. The photodetector 16 may be arranged at a distance d₂ from the second aperture 73.

The second light blocking portion 67 may, in some examples, include a light baffle portion 74 to prevent stray light passing directly between the light emitter 11 and photodetector 16.

The absorbance due to labelling particles bound within the test region 5 may be determined in a number of ways. For example, by comparing the photodetector 16 signal measured for the test region 5 before and after conducting the assay, or by comparing the photodetector 16 signal measured for the test region 5 with the photodetector 16 signal for a blank region of the lateral flow test strip 2.

Reflection based reading devices 1b for lateral flow test strips 2 have typically been designed to have a reading portion 13 which is relatively narrower than a test region 5 or control region 18 for the same reason as transmission based reading devices 1, namely to maximise signal contrast. However, such reflection based reading devices 1b for lateral flow test strips 2 may suffer from the same problems of positioning/alignment errors and low photodetector 16 signal level for the same reasons described hereinbefore.

These problems may be solved for reflection based reading devices 1b in a similar way as for the first and second reading device 26, 41.

### Third Reading Device

Referring also to FIG. 15, a third reading device 75 is shown.

The third reading device 75 includes a first light blocking member 76 which is planar and extends in first and second directions x, y. The third reading device 75 also includes a second light blocking member 77 which includes first and second planar portions 78a, 78b extending in first and second directions x, y, and arranged in the first direction x to either side of first and second aperture defining portions 79a, 79b. The planar portions 78a, 78b and the aperture defining portions 79a, 79b may be integrally formed as a single second light blocking member 77. The first light blocking member 76 and the planar portions 78a, 78b of the second light blocking member 77 are spaced apart in a third direction z, so that a first face 80 of the first light blocking members 76 is opposed to second faces 81a, 81b of the planar portions 78a, 78b of the second light blocking member 77 so as to define a sample receiving volume 27 between them. The second faces 81a, 81b may be two portions of a single face. The sample receiving volume 27 is configured to receive at least a portion of the lateral flow test strip 2 between the first and second faces 80, 81a, 81b) such that the longitudinal axis of the lateral flow test 2 is aligned in the first direction x and transverse to the third direction z. For example, the sample receiving volume 27 may be configured to allow a lateral flow test strip 2 to pass entirely through. Alternatively, the sample receiving volume 27 may have a closed terminal end (not shown), such that a lateral flow test strip 2 inserted into the sample receiving volume can only be inserted until it abuts against the closed terminal end (not shown).

The third reading device 75 also include a light emitter 32 arranged to emit light 38 at an incident angle θᵢ to the first direction x. The light emitter 32 is the same as the first and second reading devices 26, 41, except for the geometric arrangement with respect to the sample receiving volume 27. When a lateral flow test device 2 is received within the sample receiving volume 27, the light 38 intersects a surface of the lateral flow test device 2 at the incident angle θᵢ. The relatively wide reading portion 34 of the third reading device 75 is defined by a first aperture 82 through the first aperture defining portion 79a of the second light blocking member 77. The first aperture 82 is sized and positioned such that light 38 from the light emitter 32 intersects a lateral flow test strip 2 received within the sample receiving portion 27 between a pair of points xₐ, x_{b} in the first direction x. The pair of points xₐ, x_{b} define the extent of the reading portion 34. The first aperture 82 preferably extends for the width of a lateral flow test strip 2 in the second direction y, but may be narrower. The surface of a received lateral flow test strip 2 may lie in the plane containing the second planar portions 78a, 78b of the second light blocking member 77. Depending on the angular emission profile of light emitter 32, the light emitter 32 may be placed a distance d₁ from the first aperture 82 in order to provide effective collimation of the light 38. However, collimation of light 38 is relatively less important that for the reflectance based reading device 1b. When a lateral flow test strip 2 is received and the test region 5 is aligned centrally with respect to the reading portion 34, the test region 5 extends between a pair of points x₁, x₂ spaced apart in the first direction x. In contrast, to the reflectance based reading device 1b having a relatively narrow reading portion 13. The width x_{b}−xₐ of the reading portion is greater than the width x₂−x₁ of the test region 5, i.e. x_{b}xₐ≥x₂−x₁.

The third reading device 75 also includes a photodetector 37 arranged to receive light 38 reflected from the reading portion 34. The reflected light 38 reaches the photodetector 37 through a second aperture 83 through the second aperture defining portion 79b of the second light blocking member 77. The second aperture 83 is arranged to restrict the light 38 received to that which is scattered to a reflected angle θᵣ. The reflected angle θᵣ may be the same as the incident angle θᵢ, or the reflected angle θᵣ may be different to the incident angle, since the lateral flow test strip 2 will typically scatter light 38 into a wide range of angles. The photodetector 16 may be arranged at a distance d₂ from the second aperture 83.

The second light blocking portion 77 may, in some examples, include a light baffle portion 84 to prevent stray light passing directly between the light emitter 32 and photodetector 37.

The difference between the third reading device 75 and the reflectance based reading device 1b is that, in the third reading device 75, a width of the reading portion 34 in the direction perpendicular to the third direction z is greater than a width of a test region 5 parallel to the longitudinal axis of a lateral flow test strip 2. The third reading device may solve the problems of positioning/alignment errors and low photodetector signals in the same way as the first and second reading devices 26, 41.

The light emitter 32 may take the form of one or more light emitters and the photodetector 37 may take the form of one or more photodetectors. In the third reading device 75, the one or more light emitters 32 and the one or more photodetectors 37 are at least co-extensive with a projected area of the reading portion 34.

### Modifications

It will be appreciated that many modifications may be made to the embodiments hereinbefore described. Such modifications may involve equivalent and other features which are already known in the design, manufacture and use of analytical test devices and which may be used instead of or in addition to features already described herein. Features of one embodiment may be replaced or supplemented by features of another embodiment.

First and second reading devices 26, 41 have been described in which light 33 is transmitted substantially perpendicular to lateral flow test strips 2, i.e. parallel to the thickness of a lateral flow test strip 2. However, the light emitter 32 need not emit light 33 perpendicularly to lateral flow test strips 2, and instead the light 33 may be emitted in any direction transverse to the lateral flow test strip 2.

The second reading device 41 employs a light emitter 32 and photodetector 37 supported on corresponding transparent substrates 42, 43. For example, the light emitter 32 may be a bottom emitting OLED and the photodetector 37 may be a bottom absorbing OPD. However, in other examples, the reading portion 34 may be defined in part by the area of a top emitting OLED, with the encapsulation of the OLED providing the first face 28 within the reading portion 34. Similarly, the reading portion 34 may be defined in part by the area of a top absorbing OPD, with the encapsulation of the OPD providing the second face 29 within the reading portion 34. In other examples a top emitting OLED may face a top absorbing OPD to define the reading portion 34.

Although the third reading device 75 has been described using off-axis reflections for absorbance measurements, the third reading device 75 may alternatively be configured for confocal reflectance measurements. For example, using a single aperture and a partially reflective mirror or beamsplitter.

Although the first, second and third reading devices 26, 41, 75 have been described in relation to absorbance measurements, the first, second and third reading devices 26, 41, 75 may equally be used for fluorescence measurements. For a fluorescence measurement, the light emitter 32 illuminates the reading portion 34 to excite fluorescence emissions by labelling particles bound within the test region 5. A filter (not shown) may additionally be included to prevent the photodetector 37 from responding to directly transmitted or reflected light 38 emitted by the light emitter 11.

The first reading device 26 has been described as having first and second faces 28, 29 which are defined by first and second blocking substrates 30, 31 which include respective apertures 35, 36. Similarly, the second reading device 41 has been described as having first and second faces 28, 29 which are defined by first and second transparent substrates 42, 43 respectively supporting the light emitter(s) 32 and photodetector(s) 37. However, the first and second faces 28, 29 need not be similarly defined within a single reading device. For example, the first face 28 may be a face of a first light blocking substrate 30 which comprises a first aperture 35, or the first face 28 may be a face of a first transparent substrate 42 supporting the light emitter 32. Independently of how the first face 28 is defined, the second face 29 may be a face of a second light blocking substrate 31 which comprises a second aperture 36, or the second face 29 may be a face of a second transparent substrate 43 supporting the photodetector 37.

Although claims have been formulated in this application to particular combinations of features, it should be understood that the scope of the disclosure of the present invention also includes any novel features or any novel combination of features disclosed herein either explicitly or implicitly or any generalization thereof, whether or not it relates to the same invention as presently claimed in any claim and whether or not it mitigates any or all of the same technical problems as does the present invention. The applicant hereby gives notice that new claims may be formulated to such features and/or combinations of such features during the prosecution of the present application or of any further application derived therefrom.

1. A reading device for a lateral flow test strip, the reading device comprising:
a sample receiving volume disposed between first and second faces spaced apart in a first direction, the sample receiving volume configured to receive at least a portion of a lateral flow test strip between the first and second faces such that a longitudinal axis of the lateral flow test strip is aligned in a second direction transverse to the first direction;
a light emitter arranged to illuminate a reading portion of the sample receiving volume;
a photodetector arranged to receive light from the reading portion;
wherein a width of the reading portion in the second direction is greater than a width of a test region of the lateral flow test strip in the second direction, and wherein the light emitter and the photodetector are at least co-extensive with the reading portion.

2. A reading device according to claim 1, wherein the photodetector is arranged to receive:
light transmitted through the reading portion;
light reflected from the reading portion; or
fluorescence light emitted within the reading portion in response to illumination by the light emitter.

3. A reading device according to claim 1, wherein the light emitter is arranged to emit light, in the first direction, through the reading portion of the sample receiving volume; and
the photodetector is arranged to receive light transmitted through the reading portion.

4. A reading device according to claim 3, wherein the first face is a face of a first light blocking substrate which comprises a first aperture, or the first face is a face of a first transparent substrate supporting the light emitter,
wherein the second face is a face of a second light blocking substrate which comprises a second aperture, or the second face is a face of a second transparent substrate supporting the photodetector.

5. A reading device according to claim 3, wherein the first face is a face of a first light blocking substrate which comprises a first aperture,
wherein the second face is a face of a second light blocking substrate which comprises a second aperture, and
wherein the first and second apertures are co-extensive and face each other across the sample receiving volume to define the reading portion.

6. A reading device according to claim 3, wherein the first face is a face of a first transparent substrate supporting the light emitter,
wherein the second face is a face of a second transparent substrate supporting the photodetector, and
wherein the light emitter and the photodetector are co-extensive and face each other across the sample receiving volume to define the reading portion.

7. A reading device according to claim 1, wherein the light emitter is arranged to emit light at a first angle to the second direction and the photodetector is arranged to receive light reflected from the reading portion at a second angle, the reading device further comprising:
a first light blocking member, or a first portion of a light blocking member, comprising a first aperture which is arranged between the light emitter and the sample receiving volume to define the reading portion;
a second light blocking member, or a second portion of the light blocking member, comprising a second aperture which is arranged between the sample receiving volume and the photodetector.

8. A reading device according to claim 1, wherein the light emitter comprises one or more light emitters and the photodetector comprises one or more photodetectors;
wherein the one or more light emitters and the one or more photodetectors are at least co-extensive with the reading portion.

9. A reading device according to claim 1, wherein the light emitter comprises an array of inorganic light-emitting diodes or an array of organic light-emitting diodes.

10. A reading device according to claim 1, wherein the light emitter comprises a single, uniformly emissive organic light-emitting diode.

11. A reading device according to claim 1, wherein the photodetector comprises an array of inorganic photodiodes or an array or organic photodiodes.

12. A reading device according to claim 1, wherein the photodetector comprises a single, uniformly sensitive organic photodiode.

13. A reading device according to claim 1, wherein the width of the reading portion in the second direction is greater than or equal to two times the width of the test region of the lateral flow test strip in the second direction.

14. A reading device according to claim 1, wherein the width of the reading portion in the second direction is greater than or equal to 2 mm.

15. A reading device according to claim 1, wherein the width of the reading portion in the second direction is less than or equal to five times the width of the test region of the lateral flow test strip in the second direction.

16. A reading device according to claim 1, wherein the width of the reading portion in the second direction is less than or equal to 5 mm.

17. A lateral flow test device comprising:
one or more reading devices according to claim 1; and
a lateral flow test strip comprising one or more test regions, the longitudinal axis of the lateral flow test strip being aligned parallel with the second direction;
wherein each test region of the lateral flow test strip is disposed within the reading portion of a corresponding reading device.

18. A lateral flow test device according to claim 17, wherein the lateral flow test strip further comprises one or more control regions, and wherein each control region of the lateral flow test strip is disposed within the reading portion of a corresponding reading device.
